(19) United States
(12) Patent Application Publication
(10) Pub. No.: US 2010/0283661 A1
(43) Pub. Date: Nov. 11, 2010

(54) Observability of unmanned aircraft and aircraft without electrical systems

(75) Inventors: Robert C. Strain, Burke, VA (US); Matthew T. DeGarmo, Arlington, VA (US); John C. Moody, Lusby, MD (US)

Correspondence Address: STERNE, KESSLER, GOLDSTEIN & FOX P.L.L.C., 1100 NEW YORK AVENUE, N.W., WASHINGTON, DC, 20005, US

(73) Assignee: The MITRE Corporation, McLean, VA (US)

(21) Appl. No.: 12/007,872

(22) Filed: Jan. 16, 2008

Related U.S. Application Data
(60) Provisional application No. 60/880,429, filed on Jan. 16, 2007.

(51) Int. Cl. G01S 13/93

(52) U.S. Cl. 342/30

(57) ABSTRACT

The present invention relates to a lightweight beacon system, affixable, for example, to UAS, aircraft without electrical systems, airport surface vehicles, skydivers, gliders, and/or balloons. The lightweight beacon system uses a small, low-powered, portable radio beacon to broadcast the location of the aircraft, vehicle, or person to which the beacon system is attached. The lightweight beacon system is compatible with the FAA's Automatic Dependent Surveillance-Broadcast (ADS-B) service, thereby providing a means for unmanned aircraft systems (UAS), aircraft without electrical systems, airport surface vehicles, or persons to be observable to other general aviation aircraft operating in their proximity.

### CROSS-REFERENCE TO RELATED APPLICATIONS

The present application claims the benefit of U.S. Provisional Patent Application No. 60/880,429, filed Jan. 16, 2007, which is incorporated herein by reference in its entirety.

### BACKGROUND OF THE INVENTION

1. Field of the Invention

The present invention relates generally to a method and system for improving the observability of unmanned aircraft and aircraft without electrical systems. In particular, the present invention relates to a lightweight beacon system for aviation applications.

2. Background Art

With the emergence of Unmanned Aircraft Systems (UAS), Sport Aviation class aircraft, and other airspace users (e.g., balloonists, skydivers, gliders), an increasing safety risk exists due to the risk of collision of these aircraft with other aircraft that may be operating in the same airspace. As a result, UAS are presently not permitted to operate in U.S. airspace without special Federal Aviation Administration (FAA) authorization.

One solution to make airspace users more visible to others is to equip them with beaconing systems, which make them easier to locate and avoid by pilots. Typically, the region of most concern for small aircraft is within a range of a few miles. For example, the collision risk with small general aviation systems is greatest while on final approach to an uncontrolled airport outside radar coverage.

Existing surveillance systems, including current FAA certified transponder and Automatic Dependent Surveillance-Broadcast (ADS-B) avionics, require relatively heavy and expensive avionics to be integrated into the aircraft, depend on aircraft electrical power, and are not likely to be needed in uncontrolled or much of Air Traffic Controlled (ATC) airspace. These systems are predicated on the need for commercial aircraft to avoid collisions and for air traffic controllers to distinguish aircraft in controlled airspace.

As such, current airspace surveillance solutions are not practical for a significant number of small aircraft (e.g., gliders, classic aircraft, ultralight aircraft, small unmanned aircraft, balloons, skydivers, etc.), which mainly operate in uncontrolled airspace.

What is needed therefore is a surveillance beaconing system for UAS and aircraft without electrical systems that addresses the safety risk due to collision, while being compatible with the FAA's ADS-B system. Compatibility with the ADS-B system is important to ensure radio frequency compatibility and system interoperability in all airspace.

### BRIEF SUMMARY OF THE INVENTION

The present invention is directed to improving the observability of unmanned aircraft and aircraft without electrical systems. In particular, the present invention relates to a lightweight beacon system, affixable, for example, to UAS, aircraft without electrical systems, airport surface vehicles, skydivers, gliders, and/or balloons. The lightweight beacon system uses a small, low-powered, portable radio beacon to broadcast the location of the aircraft, vehicle, or person to which the beacon system is attached. The lightweight beacon system is compatible with the FAA's Automatic Dependent Surveillance-Broadcast (ADS-B) service, thereby providing a means for unmanned aircraft systems (UAS), aircraft without electrical systems, airport surface vehicles, or persons to be observable to other general aviation aircraft operating in their proximity.

Embodiments of the present invention greatly enhance general aviation safety by providing shared situational awareness among pilots and by making small aircraft and other airspace users visible in the National Airspace System (NAS). Embodiments of the present invention may also be used to simplify the identification and tracking of suspicious aircraft, thereby enhancing homeland defense and security. Furthermore, UAS operators may use embodiments of the present invention to improve their ability to maintain awareness of their aircraft and to complement sense-and-avoid techniques, required for their integration into civil airspace.

Further features and advantages of the present invention, as well as the structure and operation of various embodiments thereof, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form a part of the specification, illustrate the present invention and, together with the description, further serve to explain the principles of the invention and to enable a person skilled in the pertinent art to make and use the invention.

FIG. 1 illustrates a lightweight beacon system according to an embodiment of the present invention.

FIG. 2 illustrates an exemplary aviation scenario which benefits from using a lightweight beacon system.

FIG. 3 is a process flowchart of a method for enhancing aviation safety according to an embodiment of the present invention.

FIG. 4 is a process flowchart of a method for enhancing aviation safety according to an embodiment of the present invention.

FIGS. 5A-B illustrate an example system embodiment of the present invention.

FIG. 6 illustrates an example system embodiment of the present invention used in a small aircraft.

The features and advantages of the present invention will become more apparent from the detailed description set forth below when taken in conjunction with the drawings. In the drawings, like reference numbers generally indicate identical, functionally similar, and/or structurally similar elements. Generally, the drawing in which an element first appears is indicated by the leftmost digit(s) in the corresponding reference number.

### DETAILED DESCRIPTION OF THE INVENTION

The present invention is directed to improving the observability of unmanned aircraft systems (UAS), aircraft without electrical systems, and airport surface vehicles. In particular, the present invention relates to a lightweight beacon system, affixable, for example, to UAS, aircraft without electrical systems, airport surface vehicles (e.g., baggage carts, tugs, trucks, snow plows, lawn tractors, construction equipment, etc.), skydivers, gliders, and/or balloons. The lightweight beacon system may also be attached to land-mobile vehicles that may be part of a disaster relief, national emergency, or search-and-rescue activity, where it is desirable for ground-based and airborne assets to complement the surveillance awareness of each other or to communicate information to a centralized command and control authority.

The lightweight beacon system uses a small, low-powered, portable radio beacon to broadcast the location of the aircraft, vehicle, or person to which the beacon system is attached. The lightweight beacon system is compatible with the FAA's Automatic Dependent Surveillance-Broadcast (ADS-B) service, thereby providing a means for unmanned aircraft systems (UAS), aircraft without electrical systems, airport surface vehicles, or persons to be observable to other general aviation aircraft operating in their proximity.

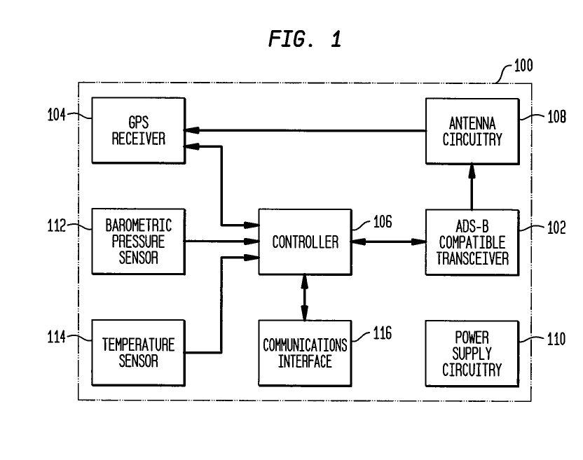

FIG. 1 illustrates a lightweight beacon system 100 according to an embodiment of the present invention. Lightweight beacon system 100 includes an ADS-B compatible transceiver 102, a Global Positioning System (GPS) receiver 104, a controller 106, antenna circuitry 108, power supply circuitry 110, a barometric pressure sensor 112, a temperature sensor 114, and a communications interface 116.

GPS receiver 104 allows beacon system 100 to periodically receive three-dimensional positional (longitude, latitude, geometric altitude) and velocity (horizontal and vertical) attributes associated with the aircraft/vehicle to which the beacon system is attached. Collectively, the positional and velocity attributes are referred to as a state vector of the aircraft/vehicle. GPS receiver 104 may be dedicated to beacon system 100 or shared with other avionics systems of the aircraft/vehicle, when available. In an embodiment, GPS receiver 104 receives wide area, regional, and/or local correction information from a GPS augmentation system. Upon receiving a state vector, GPS receiver 104 forwards the received state vector to controller 106.

Controller 106 periodically receives a state vector from GPS receiver 104 and processes the received state vector to generate an Automatic Dependent Surveillance-Broadcast (ADS-B). Controller 106 may generate the ADS-B message as a Universal Access Transceiver (UAT) ADS-B message or a 1090 MHz Extended Squitter (1090ES) ADS-B message.

In an embodiment, controller 106 generates additional positional attributes associated with the aircraft/vehicle using the attributes contained in the received state vector, and includes the additional positional attributes within the ADS-B message. Controller 106 additionally generates aircraft/vehicle state vector quality parameters and aircraft/vehicle identification information, which may also be included within the ADS-B message.

Controller 106 periodically communicates with barometric pressure sensor 112 and an optional temperature sensor 114. In an embodiment, controller 106 respectively receives periodic current pressure altitude measurements and ambient temperature measurements from barometric pressure sensor 112 and temperature sensor 114. Controller 106 may include the received measurements within the ADS-B message. Controller 106 may also use the received current pressure altitude measurements and aircraft velocity attributes from GPS receiver 104 to compensate for air pressure differences inside and outside the aircraft system to which beacon system 100 is attached. Further, controller 106 may use the received ambient temperature measurements to protect electronic components of beacon system 100 from overheating.

As would be understood by a person skilled in the art, controller 106 may include a state machine or logic processor, which governs processing within controller 106. Controller 106 can be implemented using hardware, software, and/or firmware.

After generating the ADS-B message, controller 106 forwards the generated ADS-B message to ADS-B compatible transceiver 102.

ADS-B compatible transceiver 102 includes an ADS-B compatible transmitter, capable of transmitting UAT ADS-B messages and 1090ES ADS-B messages. ADS-B compatible transceiver 102 further includes an ADS-B compatible receiver, capable of receiving UAT ADS-B messages and 1090ES ADS-B messages. In an embodiment, ADS-B compatible transceiver 102 uses the UAT waveform on the 978 MHz frequency and complies with ADS-B performance requirements. In an alternative embodiment, ADS-B compatible transceiver 102 uses the 1090 Extended Squitter (ES) ADS-B waveform on the 1090 MHz frequency. As such, ADS-B compatible transceiver 102 allows beacon system 100 to interoperate with the FAA's Automatic Dependent Surveillance-Broadcast (ADS-B) system.

ADS-B compatible transceiver 102 receives the generated ADS-B message from controller 106. In an embodiment, ADS-B compatible transceiver 102 acts on the received ADS-B message to condition the information for radio frequency transmission. This, for example, includes digital-to-analog conversion and frequency upconversion. ADS-B compatible transceiver 102 then uses antenna circuitry 108 to broadcast the ADS-B message.

In another embodiment, ADS-B compatible transceiver 102 receives ADS-B messages transmitted by other airspace users and forwards the received ADS-B messages to controller 106. Controller 106 then processes the received ADS-B messages to generate positional attributes and/or status information associated with the other airspace users. Additionally, controller 106 may receive UAT messages transmitted by ground stations and/or other airspace users, which may include operation-specific information (e.g., fire-fighting information, search-and-rescue data information, airspace utilization commands, etc.), for example.

Controller 106 may forward the generated positional attributes, status information, and/or operation-specific information to an external system. In another embodiment, controller 106 uses messages received from ADS-B ground stations to verify the positional information received from GPS receiver 104 or in lieu of the positional information received from GPS receiver 104, when said positional information is determined to be inaccurate or is unavailable.

As shown in FIG. 1, beacon system 100 further includes a communications interface 116, which communicates with controller 106. Communications interface 116 allows beacon system 100 to communicate with an external system and/or a user. In an embodiment, communications interface 116 is used to receive configuration commands and/or operation-specific data from and/or send received message information to an external system or user. In another embodiment, communications interface 116 is used to receive information from an external system to broadcast via ADS-B compatible transceiver 102, thereby allowing beacon system 100 to act as a broadcast repeater. For example, the external system may be a UAS ground control station that uses beacon system 100 to broadcast information to airspace users. The broadcast information may include ADS-B messages, but may also be other than ADS-B messages and include operation-specific information (e.g., airspace restrictions, flight path directions, specialized reports, etc.) directed to other airspace users. In another embodiment, the external system may be a centralized command and control system used within a disaster relief, national emergency, or search-and-rescue activity, to increase the surveillance awareness of both ground-based and airborne assets.

As described above, beacon system 100 includes a barometric pressure 112 and a temperature sensor 114. Barometric pressure sensor 112 allows beacon system 100 to periodically acquire pressure altitude of the aircraft system to which the beacon system is attached. Pressure sensor 112 is of sufficient performance quality to meet aviation standards. In an embodiment, pressure sensor 112 provides a range of voltages to controller 106, which generates pressure altitude measurements for inclusion in the ADS-B message. Temperature sensor 114 provides measurements of ambient temperature within beacon system 100 to controller 106.

Lightweight beacon system 100 is powered using power supply circuitry 110. In an embodiment, power supply circuitry 110 includes one or more batteries that may be re-chargeable. This, for example, may be used with aircraft systems having no electrical systems. In another embodiment, power supply circuitry 110 derives power from an external power system that may be available in the aircraft. Other methods for deriving power to operate beacon system 100 (e.g., solar power) may also be possible as would be understood by a person skilled in the art.

Lightweight beacon system 100 can be a stand-alone device. In an embodiment, as a stand-alone package, lightweight beacon system 100 will have approximately the size and weight of a Personal Digital Assistant (PDA) and 2-12 hours of battery life. Alternatively, lightweight beacon system 100 may be integrated within a larger system, which may include other sources of power and/or other types of situational sensors and supporting electronic circuitry (e.g., electronic avionics system of aircraft).

Further, several installation options are available for lightweight beacon system 100. In an embodiment, beacon system 100 may be integrated in a self-contained portable unit that can be affixed, for example, to the payload of the aircraft system or to the body of a skydiver. As such, all components of lightweight beacon system 100 are integrated within a single unit. Alternatively, components of lightweight beacon system 100 may be located apart from each other. For example, any one of GPS receiver 104, power supply circuitry 110, and antenna circuitry 108 may be located externally relative to the other components of lightweight beacon system 100. Furthermore, certain components (e.g., GPS receiver 104, antenna circuitry 108) may be permanently or temporarily affixed to the aircraft system and/or other components of beacon system 100.

As will be further described below, embodiments of the present invention can be used to increase aviation safety, by reducing the risk of collision between aircrafts. Further advantages of embodiments of the present invention include decreased emergency response time for locating downed or missing aircraft, more effective and safer emergency response to national emergencies or natural disasters due to the ease of deployment of lightweight beacon systems on aircrafts, enhanced national defense and security due to the increased ability to locate and track an aircraft with an affixed beacon system, and enhanced effective use of national airspace where the operation of UAS, aircraft without electrical systems, and/or airport surface vehicles is common.

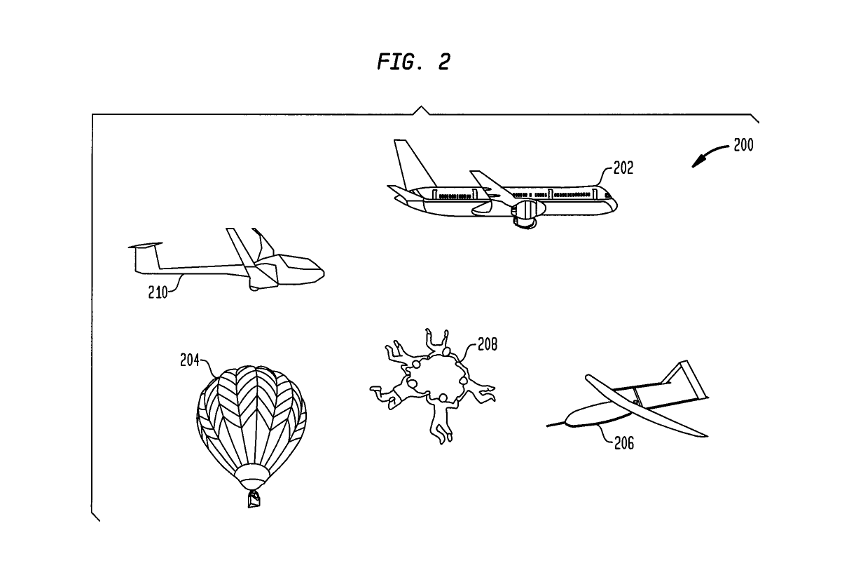

FIG. 2 illustrates an exemplary scenario 200 in which a lightweight beacon system according to the present invention can be used to increase aviation safety. Exemplary scenario 200 illustrates an airplane 202, a hot air balloon 204, an unmanned aircraft vehicle 206, a group of skydivers 208, and a glider 210, which may be in proximity with each other.

Airplane 202 is equipped with an FAA certified transponder and Automatic Dependent Surveillance-Broadcast (ADS-B) avionics. As such, airplane 202 is capable of observing other general aviation aircraft that are within a certain range therefrom. Typically, however, balloon 204, UAV 206, the group of skydivers 208, and glider 210 are not visible to the avionics of airplane 202, as they may not be carrying transponder/receiver systems or have transponder/receiver systems incompatible with those available at airplane 202. As a result, a risk of collision exists in exemplary scenario 200 between any of the illustrated aircraft systems 204, 206, 208, 210 and airplane 202 when they come in proximity with each other. In particular, a pilot of airplane 202 is not able to see small aircraft and thus would not be able to avoid such risk of collision.

A lightweight beacon system, as illustrated above in FIG. 1, can be used to increase aviation safety in exemplary scenario 200. For example, by equipping balloon 204, UAV 206, glider 210, and/or the group of skydivers 208 with lightweight beacon system 100, they can be made observable to airplane 202. As noted above, lightweight beacon system 100 includes an ADS-B compatible transceiver capable of transmitting a position report that is readable by ADS-B avionics. As such, the risk of collision of airplane 202 with any one of balloon 204, UAV 206, glider 210, and the group of skydivers 208 can be significantly decreased. Furthermore, lightweight beacon system 100 may be combined with automated message processing to track the location and movement of proximate aircraft/vehicles and compute flight trajectories to avoid collision. Resulting collision avoidance algorithms, when coupled with lightweight beacon system 100, aid the aircraft/vehicle operator in reducing the risk of collision.

Note that lightweight beacon system 100, having an ADS-B compatible receiver, may receive as well as transmit position reports. As such, balloon 204, UAV 206, glider 210, and the group of skydivers 208 can also be made observable to one another.

Exemplary scenario 200 is only one example in which lightweight beacon system 100 can be used to increase aviation safety. Other scenarios, as would be understood by a person skilled in the art, exist including those occurring in the air or on the airport tarmac.

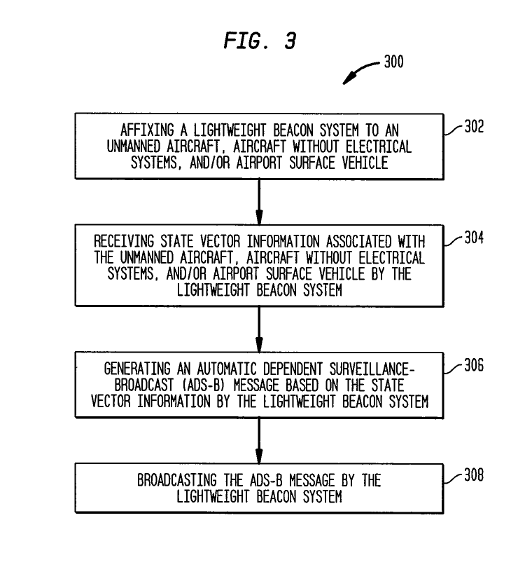

FIG. 3 is a process flowchart 300 of a method for enhancing aviation safety according to an embodiment of the present invention. The method can be used to enhance aviation safety when unmanned aircraft, aircraft without electrical systems, and/or airport surface vehicles are present.

Process 300 begins in step 302, which includes affixing a lightweight beacon system to an unmanned aircraft, aircraft without electrical systems, and/or airport surface vehicle. For example, step 302 may include affixing a lightweight beacon system to skydivers, gliders, and/or air balloons.

Step 304 includes receiving state vector information associated with the unmanned aircraft, aircraft without electrical systems, and/or airport surface vehicle by the lightweight beacon system. In an embodiment, the state vector information includes positional and velocity attributes associated with the unmanned aircraft, aircraft without electrical systems, and/or airport surface vehicle.

Step 306 includes generating an Automatic Dependent Surveillance-Broadcast (ADS-B) message based on the received state vector information by the lightweight beacon system. In an embodiment, the ADS-B message is a UAT ADS-B message or a 1090ES ADS-B message.

Subsequently, step 308 includes broadcasting the ADS-B message by the lightweight beacon system.

Process 300 may further include communicating via the lightweight beacon system with an external system or user to receive configuration commands from and/or to send events to the external system or user, or receiving information from an external system and broadcasting the received information by the lightweight beacon system. The received information may include ADS-B messages, but may also be other than ADS-B messages and include operation-specific information (e.g., airspace restrictions, flight path directions, specialized reports, etc.) directed to other airspace users. In an embodiment, the external system includes an Unmanned Aircraft System (UAS) ground control station. In another embodiment, the external system may be a centralized command and control system used within a disaster relief, national emergency, or search-and-rescue activity, to increase the surveillance awareness of both ground-based and airborne assets.

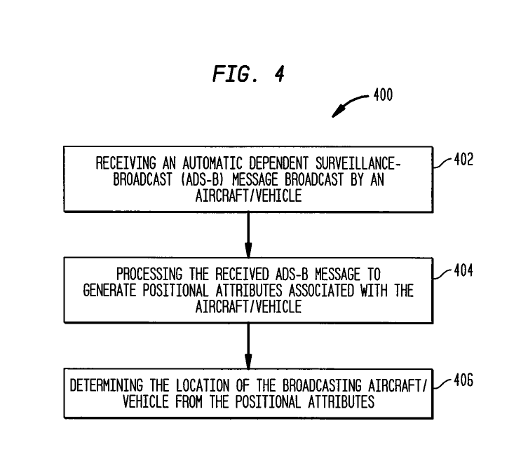

The ADS-B message broadcast by the lightweight beacon system may be received by nearby airspace users. FIG. 4 illustrates a process flowchart 400 according to an embodiment of the present invention. Process 400 begins in step 402, which includes receiving an ADS-B message broadcast by an aircraft/vehicle. Process 400 then proceeds to step 404, which includes processing the received ADS-B message to generate positional attributes associated with the aircraft/vehicle. In an embodiment, the positional attributes include 3-dimensional (longitude, latitude, geometric altitude) positional attributes. Then, in step 406, process 400 includes determining the location of the broadcasting aircraft/vehicle from the generated positional attributes.

Embodiments of the present invention according to process 400 can be used to detect the presence of unmanned aircraft, aircraft without electrical systems, and/or airport surface vehicles, thereby reducing the risk of collision with these types of aircraft/vehicles. Further, these embodiments can be used by general aviation aircraft and/or unmanned aircraft, aircraft without electrical systems, and airport surface vehicles.

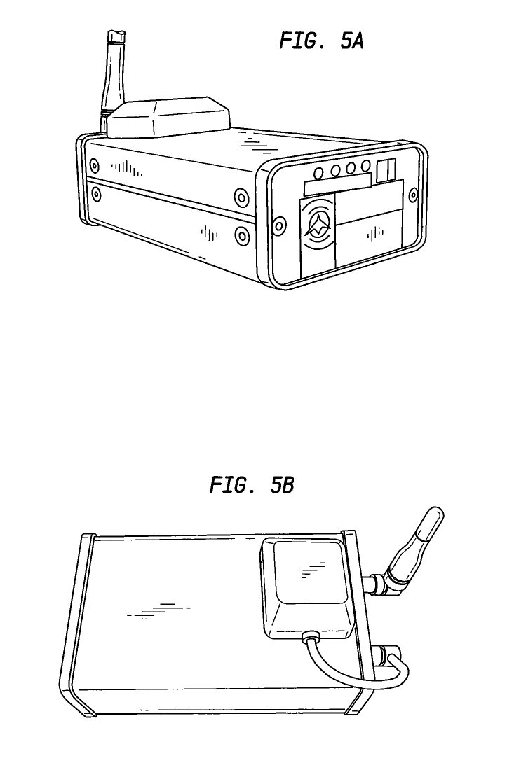

FIGS. 5A-B illustrate different views of an example system embodiment of the present invention.

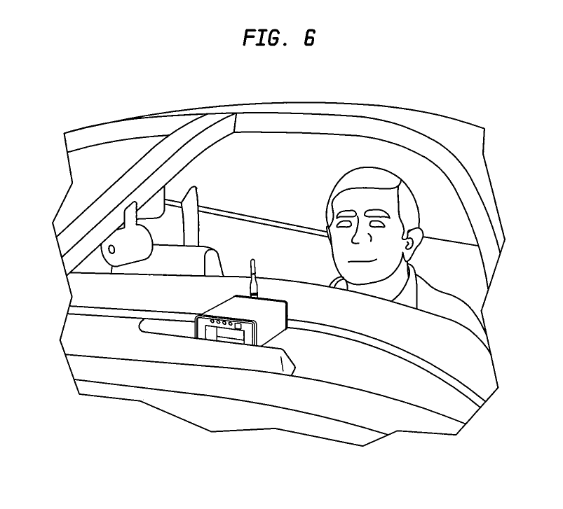

FIG. 6 illustrates an example system embodiment of the present invention affixed in a small aircraft.

While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

What is claimed is:

1. A lightweight beacon system affixable to an aircraft system, comprising:
a Global Positioning System (GPS) receiver that receives a state vector associated with an aircraft system, wherein said state vector includes positional and velocity attributes of said aircraft system;
a controller that processes said state vector and generates an Automatic Dependent Surveillance-Broadcast (ADS-B) message based on said state vector; and
an ADS-B compatible transceiver configured to broadcast said ADS-B message.

2. The beacon system of claim 1, wherein said controller generates additional positional attributes associated with said aircraft system and includes said additional positional attributes within said ADS-B message.

3. The beacon system of claim 1, wherein said beacon system further comprises a barometric pressure sensor, wherein said barometric pressure sensor periodically communicates current pressure altitude measurements to said controller, and wherein said controller includes said pressure altitude measurements within said ADS-B message.

4. The beacon system of claim 1, wherein said beacon system further comprises a temperature sensor, wherein said temperature sensor periodically communicates ambient temperature measurements to said controller, and wherein said controller includes said ambient temperature measurements within said ADS-B message.

5. The beacon system of claim 1, wherein said controller generates said ADS-B message as a Universal Access Transceiver (UAT) ADS-B message or a 1090 MHz Extended Squitter (1090ES) ADS-B message.

6. The beacon system of claim 1, wherein said GPS receiver receives wide area, regional, and/or local correction information from a GPS augmentation system.

7. The beacon system of claim 1, wherein said GPS receiver is shared with other avionics systems of said aircraft system.

8. The beacon system of claim 1, wherein said ADS-B compatible transceiver includes an ADS-B compatible transmitter, capable of transmitting at least one of an Universal Access Transceiver (UAT) ADS-B message and a 1090ES ADS-B message.

9. The beacon system of claim 1, wherein said ADS-B compatible transceiver includes an ADS-B compatible transceiver, capable of receiving at least one of an Universal Access Transceiver (UAT) ADS-B message and a 1090ES ADS-B message.

10. The beacon system of claim 1, further comprising a communications interface, wherein said communications interface communicates with an external system or user to receive configuration commands from and/or send events to said external system or user.

11. The beacon system of claim 1, wherein said beacon system receives information from an external system via said communications interface and broadcasts said information using said ADS-B compatible transceiver, thereby acting as a broadcast repeater.

12. The beacon system of claim 11, wherein said external system includes a Unmanned Aircraft System (UAS) ground control station.

13. The beacon system of claim 11, wherein said information is other than an ADS-B message and includes operation-specific information directed to other aircraft systems.

14. The beacon system of claim 1, wherein said controller processes ADS-B messages received by said ADS-B compatible transceiver from other airspace users and generates positional attributes and status information associated with said other airspace users.

15. The beacon system of claim 1, wherein said controller processes messages, other than ADS-B messages, received by said ADS-B compatible transceiver from one or more ground stations to determine the location of the aircraft system.

16. The beacon system of claim 1, further comprising antenna circuitry.

17. The beacon system of claim 1, further comprising power supply circuitry.

18. The beacon system of claim 17, wherein said power supply circuitry includes one or more batteries.

19. The beacon system of claim 17, wherein said power supply circuitry derives power from an external source.

20. The beacon system of claim 1, wherein said beacon system is integrated within a single portable unit.

21. The beacon system of claim 1, wherein said beacon system is affixable to unmanned aircraft systems, aircraft without electrical systems, airport surface vehicles, skydivers, gliders, and/or balloons.

22. The beacon system of claim 1, wherein said beacon system is integrated within an electronic avionics system of the aircraft.

23. A method for enhancing aviation safety in the presence of unmanned aircraft, aircraft without electrical systems, and/or airport surface vehicles, comprising:
affixing a lightweight beacon system to an unmanned aircraft, aircraft without electrical systems, and/or airport surface vehicle;
receiving state vector information associated with said unmanned aircraft, aircraft without electrical systems, and/or airport surface vehicle by said lightweight beacon system;
generating an Automatic Dependent Surveillance-Broadcast (ADS-B) message based on said state vector information by said lightweight beacon system; and
broadcasting said ADS-B message by lightweight beacon system.

24. The method of claim 23, wherein said aircraft without electrical systems include one of a skydiver, a glider, and/or an air balloon.

25. The method of claim 23, further comprising:
receiving said ADS-B message; and
detecting the presence of said unmanned aircraft, aircraft without electrical systems, and/or airport surface vehicle, thereby reducing a risk of collision with said unmanned aircraft, aircraft without electrical systems, and/or airport surface vehicle.

26. The method of claim 23, further comprising:
communicating with an external system or user to receive configuration commands from and/or to send events to said external system or user.

27. The method of claim 23, further comprising:
receiving information from an external system; and
broadcasting said received information by said lightweight beacon system.

28. The method of claim 27, wherein said external system includes an Unmanned Aircraft System (UAS) ground control station.

29. The method of claim 27, wherein said information is other than an ADS-B message and includes operation-specific information directed to other aircraft systems.

30. The method of claim 23, wherein said generating step comprises generating a Universal Access Transceiver (UAT) ADS-B message or a 1090ES ADS-B message.
